(19) United States
(12) Patent Application Publication
(10) Pub. No.: US 2013/0153494 A1
(43) Pub. Date: Jun. 20, 2013

(54) METHODS AND APPARATUSES FOR WATER AND WASTEWATER TREATMENT

(71) Applicants: Jianmin Wang, Rolla, MO (US); Tim Canter, St. Louis, MO (US)

(72) Inventors: Jianmin Wang, Rolla, MO (US); Tim Canter, St. Louis, MO (US)

(21) Appl. No.: 13/567,850

(22) Filed: Aug. 6, 2012

Related U.S. Application Data
(60) Provisional application No. 61/515,855, filed on Aug. 6, 2011.
(60) Provisional application No. 61/515,967, filed on Aug. 7, 2011.
(60) Provisional application No. 61/521,653, filed on Aug. 9, 2011.
(60) Provisional application No. 61/525,760, filed on Aug. 20, 2011.

(51) Int. Cl. C02F 3/02; F17D 1/00

(52) U.S. Cl. CPC C02F 3/02; F17D 1/00
USPC 210/620; 210/150; 137/561 R; 137/1

(57) ABSTRACT

Described herein are methods and devices for biologically treating water and/or wastewater. The methods and devices for treating waste water may be enhanced using an air-lift device which moves water and/or solids using volumes of air. This device can provide occasional surges of water using large bubbles which are able to move great volume of liquid while minimizing dissolved oxygen transfer to the surrounding liquid. Use of the devices and processes herein provides a simple, eloquent approach to waste water treatment with less operation and maintenance costs than conventional devices and/or processes.

### CROSS-REFERENCE TO RELATED APPLICATION(S)

This application claims priority to U.S. Provisional Patent Application No. 61/515,855, filed Aug. 6, 2011; U.S. Provisional Patent Application No. 61/515,967, filed Aug. 7, 2011; U.S. Provisional Patent Application No. 61/521,653, filed Aug. 9, 2011; and to U.S. Provisional Patent Application No. 61/525,760, filed Aug. 20, 2011.

### BACKGROUND

The wastewater containing organic pollutants is usually treated using a biological process. The suspended-growth process, which is also known as the activated sludge process, is one of the most widely used biological processes. For example, most municipal wastewater treatment plants employ the activated sludge process in their secondary treatment stage for removing organic pollutants from the wastewater. The conventional activated sludge process comprises a suspended-growth bioreactor (conventionally referred as the aeration tank when operated in aerobic conditions) and a clarifier (conventionally referred as the secondary clarifier). The wastewater and the return activated sludge from the clarifier flow into the aeration tank. Air or oxygen is supplied to the aeration tank through an aeration system. In the aeration tank, pollutants are either degraded or adsorbed by the activated sludge. The aeration tank mixed liquor then enters the secondary clarifier for solid-liquid separation. The supernatant of the secondary clarifier is discharged through the clarifier outlet. Most of the settled sludge in the clarifier is returned back to the aeration tank. Excess sludge is wasted to a sludge handling system for further treatment. Wasted sludge or high concentrated wastewater can be treated using anaerobic method to produce biogas while reducing pollutant load.

In most cases, the wastewater also contains organic nitrogen, ammonia, and phosphorus. They are called wastewater nutrients because they can cause the excessive growth of algae in the receiving water body. In addition, the organic nitrogen and ammonia consume oxygen in the receiving water body during their oxidation. These wastewater nutrients can also be removed in the bioreactor. Microorganisms can convert organic nitrogen and ammonia to nitrate or nitrite under aerobic conditions. This process is called nitrification. If the bioreactor or part of the reactor is under anoxic conditions (no dissolved oxygen (DO) presents), microorganisms can reduce the nitrate and nitrite to nitrogen gas. This process is called denitrification. If the bioreactor is maintained in low DO aerobic conditions, simultaneous nitrification/de-nitrification can be achieved. If the aerobic sludge continuously passes through an anaerobic zone then an aerobic zone in the bioreactor, a group of microorganisms favorable for phosphorus uptake can be acclimated.

The combination of nitrification/denitrification processes can be achieved in a number of ways.

The conventional method includes a bioreactor and a secondary clarifier. The bioreactor includes two zones or two individual tanks: an aerobic zone/tank for nitrification, and an anoxic zone/tank for denitrification. Activated sludge is returned from the clarifier to the bioreactor to maintain a certain amount of biomass for nitrification and denitrification. If the anoxic zone is ahead of the aerobic zone, it is called a “pre-anoxic” process. For this process, organic matter in the influent is used as the electron donor for denitrification, thereby removing some organic matter during denitrification. However, this process relies on the return of final sludge and/or mixed liquor to provide nitrate to the anoxic zone. Therefore, only the nitrite/nitrate contained in these return streams can be removed. A certain fraction of the nitrate/nitrite in the aerobic zone (depending on the return ratio) is never returned to the anoxic zone, which limits the extent of denitrification. If the aerobic zone is ahead of the anoxic zone, it is called a “post-anoxic” process. This process cannot use influent organic carbon for denitrification. Therefore, the denitrification rate is generally very slow and an external carbon source is usually added to promote denitrification. Carbon addition increases operational complexity and cost.

The step-feed/step-aeration process is also used to perform nitrification and denitrification. In this process the bioreactor is separated into several sequential anoxic/aerobic sections. Aeration is provided in aerobic sections to perform nitrification. However, raw wastewater is fed into each of the anoxic sections and mixed with the nitrified mixed liquor from the preceding aerobic section for denitrification. This process can use the organic matter in the raw wastewater for denitrification. However, sludge return from a secondary clarifier to the first anoxic zone is needed to provide sufficient biomass for both nitrification and denitrification.

There is also an alternating aerobic-anoxic process for total nitrogen removal. In this process the bioreactor is not separated into different sections, but rather creates aerobic and anoxic conditions within the same volume at different times. Aeration is applied to create the aerobic condition and nitrification is accomplished. Aeration is then ceased and anoxic condition begins. During the anoxic condition inflow commences, and denitrification is performed. Again this process requires a secondary clarifier for solids-liquid separation and a separate sludge return system to seed the bioreactor for biological reactions.

The simultaneous nitrification/denitrification process is also used to perform nitrification and denitrification within one tank. In this process, the entire tank is maintained under a low DO condition so that anoxic conditions can be maintained inside the flocs of activated sludge, allowing the nitrate/nitrite that has diffused into the flocs to be denitrified. However, it is not easy to maintain precise DO concentrations, and a complex control system must be used. In addition, low DO reduces the rate of nitrification. This process also requires a secondary clarifier to perform solids-liquid separation and a separate sludge return system to seed the bioreactor.

The sequencing batch reactor (SBR) can achieve nitrification, denitrification, and solids-liquid separation within one tank. During the aeration period nitrification occurs, while denitrification occurs during the feeding and mixing period. Sludge is settled and retained within the same tank during the settling period. However, after nitrification a fraction of the nitrate in the supernatant must be decanted to allow a new feeding cycle to begin. The effluent nitrate concentration is dependent on the influent total nitrogen concentration and the fraction of feed volume to total tank volume in one cycle. Therefore, only the portion of nitrate in the tank after decanting can be denitrified. Due to the use of the mechanical decanting system inherent to the SBR process, frequent but small volume decanting and feeding, which is essential to reduce the final effluent nitrate concentration, is not possible; therefore the total effluent nitrate concentration cannot be maintained at desirably low level. Moreover, the decanting process uses many mechanical moving parts, all of which can be problematic for operation

FIG. 1 shows a conventional pre-anoxic process for total nitrogen removal. It has an anoxic zone for denitrification followed by an aerobic zone for BOD degradation and nitrification. Mixed liquor in the aerobic zone is forcibly returned to the anoxic zone to provide nitrate. The effluent from the aerobic zone flows through a secondary clarifier for solids-liquid separation, and settled sludge in the secondary clarifier is returned to the anoxic zone to provide appropriate amount of biomass needed for biological functions. Supernatant in the secondary clarifier is discharged. The anoxic zone is continuously mixed, mostly through mechanical mixing devices.

FIG. 2 shows a conventional step-feed process for comprehensive nitrification and denitrification. It includes several sections or zones that alternatively perform denitrification and nitrification. Similar to the pre-anoxic process, it has a separate secondary clarifier and sludge is returned from the secondary clarifier to the first anoxic zone, and all anoxic zones are continuously mixed, mostly through mechanical mixing devices. The influent is fed to multiple anoxic zones to reduce the amount of nitrate produced in the following aerobic zone, and to provide carbon source for denitrification. This process can achieve better total nitrogen removal.

FIG. 3 shows a bioreactor such as is disclosed in US Patent No. 6,787,035 that has been designed with an internal settling device (24, 26, 28, 30) to automatically return sludge to the aerobic zone (18). This system uses an aerobic zone (18) for BOD removal and nitrification, and returns a portion of the liquor to a pre-anoxic zone (16) for denitrification. Supplemental sludge is returned from final clarifier (36) back to the bioreactor through a sludge return device (38). During normal operation, influent is continuously fed to the bioreactor and the aeration device (22) is continuously operated to charge oxygen to the bioreactor.

Anaerobic digesters have been used in many areas of the world to produce biogas for cooking, heating, and electricity using human and animal wastes, high strength wastewater, and sludge. The major component of an anaerobic digester is a tank. This tank receives and digests organic matter under anaerobic conditions. During digestion microorganisms convert the organic matter to methane gas after several metabolic steps.

The key difference between a high-rate anaerobic digester and a conventional anaerobic digester is mixing. Appropriate mixing can significantly improve the digestion performance because it provides better contact between the microorganisms and the organic materials, prevents the sludge build up, and breaks apart floating sludge. For large installations, high-rate anaerobic digesters are normally used. A number of mixing methods such as mechanical mixing and gas mixing have been applied. These mixing types usually need external energy input and periodic maintenance. For example, mechanical mixing requires impellers and motors. Gas mixing, although relatively mild, still requires a gas compressor to recycle the gas from the top of the tank to the bottom of the tank. For small installations (such as those used in households and small communities), however, it is not cost-effective to employ these mixing methods. In particular, the application of these mixing methods is not possible in regions where there is no electricity. As a result, only bulky conventional anaerobic digesters, which do not have deliberated mixing systems, are used as biogas generators.

The effort to install conventional anaerobic digesters for small installations is significant. The key roadblock for mass implementation of these conventional digesters is their large size. Large tank volumes require large footprints and significant cost for construction, and these tanks need to be constructed onsite in most cases. Large tanks are also prone to leaking—and biogas leaking is the primary cause of biogas generator failure. Large tank designs are required because of the low reaction rate due to the lack of appropriate mixing. Only very mild mixing exists, caused naturally by the rising of small biogas bubbles.

While some past iterations of anaerobic digesters have relied on propeller-type mixing devices inserted into the tank, prior art shows improvements to mixing within anaerobic digesters using draft tube mixing units. The draft tube mixing unit typically contains a self-contained, propeller-type agitator that induces flow from the top of the tank, just below the liquid's surface, to the bottom of the tank. If more than one draft tubes are utilized in a single tank then the outlets of the draft tubes are aligned in a way as to induce a vortex with in the reactor. This provides two crucial functions: first, as previously mentioned, turbulence within the reactor increases contact frequency between microbes and substrate, increasing metabolic activity and gas production; secondly, agitation of the surface can break apart floating sludge and reintroduce it to the mixture. Too much floating sludge can create operational issues for anaerobic digesters including decreased gas production and clogging of effluent pipes.

The advent of high-efficiency, completely-mixed anaerobic digesters resulted in a decrease in overall reactor size for the same biogas yield. A portable anaerobic digester capable of high-efficiency anaerobic digestion typically has components of similar reactors (i.e., influent pipe, effluent pipe, sludge wasting pipe, etc.). Such reactors may use a single impeller or multiple impellers to lift solids from the bottom of the reactor and distribute them across the top of the reactor, which also has the effect of breaking apart any floating sludge. Other types of common mixing devices may also be used, such as a draft tube, injected gas, vacuum pumping, mixing blades and the like. The effluent port is typically positioned below the level of the fluid to minimize clogging occurrence as the result of floating sludge. Although this type of reactor is able to achieve higher biogas generation per volume of reactor over conventional non-mixed designs, the net energy output of the reactor is reduced due to the energy input needed to drive the mixing mechanism.

Fluids or fluid-like substances are often transported against gravity by the use of mechanical devices that provide positive and negative displacement (e.g., diaphragm pumps) or that apply kinetic energy directly to the fluid (e.g., centrifugal pumps). These types of devices often have many mechanical moving parts and, therefore, require significant amounts of maintenance.

Traditional airlift pumps can also be used to move and mix fluids. The traditional airlift pump has several advantages over mechanical pumps in that they generally have no moving parts in the pump that can fail due to mechanical wear. An air source provides the driving force in the pump, allowing for easy or no pump maintenance. Furthermore, airlift pumps are robust, light, and easy to install and transport compared to their mechanical counterparts. In a traditional air-lift pump, when air is introduced into a riser the density of the fluid in the riser is decreased, allowing for liquid and solids transport from the bottom to the top of the riser.

Conventional airlift pumps have disadvantages as well. Perhaps the most significant is the inability to apply a great deal of head or pressure to the fluid. In addition, airlift pumps are limited by relatively small pump housing diameters therefore may not able to achieve high flow rates. If the pump housing of an airlift pump has a large diameter, than the air bubbles within the housing are relatively more dispersed and can not form large bubbles within the housing. Therefore, lifting force is reduced with an increase of the pump housing diameter.

If there is a method and apparatus that can form large gas bubbles within the pipe to lift the liquid, the pump performance would be improved. In addition, the pump housing diameter can be increased without losing lifting force, thus achieving higher flow rates. The intensive lifting force caused by the large gas bubble can also be used for mixing the fluid within various types of reactors.

Some methods for improving the efficiency of air-lift pumps do so by introducing air to an airlift pump so as to allow the gas to accumulate in a volume under the liquid surface. Once the gas reaches a predetermined volume a large bubble of gas enters the pump riser through an orifice. Such devices may be thought of as “surge lift” devices as they collect a predetermined volume of gas and release it in a single “surge” to improve performance. The large bubble expands as it rises due to decreasing fluid pressure. As the bubble expands it fills the entire riser, creating a much greater force than the small bubbles in a traditional airlift pump. In other methods a gas supply line has been added to allow the pump to operate as a traditional airlift pump between large-bubble surges, effectively increasing overall flow rate. All of these previous methods for increasing the efficiency of an air-lift pump include an elbow-shaped means of introducing the air from the air chamber to the riser. In certain applications this means of air introduction could become clogged and result in pump failure.

### SUMMARY

One embodiment of the disclosed invention is a suspended-growth bioreactor and method comprising one or more mixing zones that are operated under anaerobic or anoxic conditions, an aerobic zone for nitrification and BOD removal, an open- or closed-bottom static zone for sludge settling and thickening, a liquid conveyance device to return sludge from the static zone to a mixing zone, or between mixing zones, and may include a means to automatically return biomass from the static zone to the aerobic zone. A series of mixing zones can be applied to increase treatment effectiveness for denitrification and/or phosphorus removal. The mixing within the different zones is accomplished by an air-driven surge lifting device.

Another embodiment of the disclosed invention is a suspended-growth bioreactor and process that apply an internal sludge return function to replace the conventional sludge return from the final clarifier for treating water and wastewater, and accomplishes alternating operating conditions within a single volume in the reactor to facilitate specific microbiological functions at different times. It comprises an alternating reaction zone operated under alternating mixing/anaerobic conditions for pollutant removal, a static zone for sludge settling and thickening, and a means to return biomass solids from the static zone to the alternating reaction zone. The mixing may be accomplished by a gas-driven surge lifting device.

Yet another embodiment of the disclosed invention includes a bioreactor which alternates between mixing and aerobic conditions to promote microbiological processes that occur with and without oxygen. During the aerobic phase BOD within the reactor is converted to carbon dioxide and biomass, and ammonia-nitrogen/organic nitrogen are converted to nitrate or nitrite. During the anoxic phase influent enters the reactor to provide a carbon source for denitrification, and nitrate or nitrite are converted to nitrogen gas. Mixing occurs via mixing devices during the anoxic phase. When the anoxic mixing period is extended, an anaerobic condition occurs, which encourages the growth of phosphorus accumulating organisms within the reactor to achieve biological phosphorus removal.

In still another embodiment of the disclosed invention it may be desirable to improve biological treatment by adding an anaerobic zone upstream of the alternating zone. In some instances it may include a means to transport biomass solids from the static zone to the anaerobic or both the anaerobic and alternating reaction zones. In addition, solids in the static zone could also be transported to the alternating reaction zone rather than allowing the natural hydraulic forces in the reactor to perform sludge return.

Another embodiment of the disclosed invention describes a method and apparatus to create large diameter gas bubbles within a pump housing (such as airlift pump) to provide higher lifting potential over conventional designs. This particular embodiment includes a gas collection chamber and the means to transfer gas to the pump housing. The gas collection chamber coalesces small gas bubbles to a certain volume before periodically discharging them into the pump riser. As a result, large gas bubbles within the pump riser force the liquid within the pump riser to move upward via the buoyant force of the gas.

Still another embodiment of the disclosed invention describes a method and apparatus to anaerobically digest organic materials such as animal and human wastes, biosolids, wastewater, etc. and to produce biogas. This particular embodiment comprises a tank and an automatic mixing device. In this case biogas bubbles produced in the lower portion of the tank are collected and coalesced. After reaching a certain volume the gas is released to a riser at once, creating a significant suction within the riser that transports solids and liquid from the bottom of the tank to the upper level of the tank and effectively mixing the tank. This mixing function also reduces possible sludge build up at the tank bottom and breaks up the floating sludge within the tank. The tank content is displaced through the outlet after addition of the new feed.

### BRIEF DESCRIPTION OF THE DRAWINGS

FIG. 1 is a flow diagram of a conventional pre-anoxic waste treatment process.

FIG. 2 is a flow diagram of a conventional step-fixed nitrification and denitrification process.

FIG. 3 is a cross sectional view of a bioreactor from U.S. Pat. No. 6,787,035.

FIG. 4 is a cross sectional view of a bioreactor according to one embodiment of the disclosed invention.

FIG. 5 is a cross sectional view of a bioreactor according to another embodiment of the disclosed invention.

FIG. 6 is a cross sectional view of a bioreactor according to still another embodiment of the disclosed invention.

FIG. 7 is a cross sectional view of a bioreactor according to yet another embodiment of the disclosed invention.

FIG. 8 is a cross sectional view of a lift device according to one embodiment of the disclosed invention.

FIG. 9 is a cross sectional view of a lift device according to another embodiment of the disclosed invention.

FIG. 10 is a cross sectional view of a lift device according to yet another embodiment of the disclosed invention.

FIG. 11 is a cross sectional view of a reactor and lift device according to one embodiment of the disclosed invention.

FIG. 12 is a cross sectional view of a reactor and lift device according to another embodiment of the disclosed invention.

FIG. 13 is a cross sectional view of a reactor and lift device according to still another embodiment of the disclosed invention.

FIG. 14 is a cross sectional view of a reactor and lift device according to yet another embodiment of the disclosed invention.

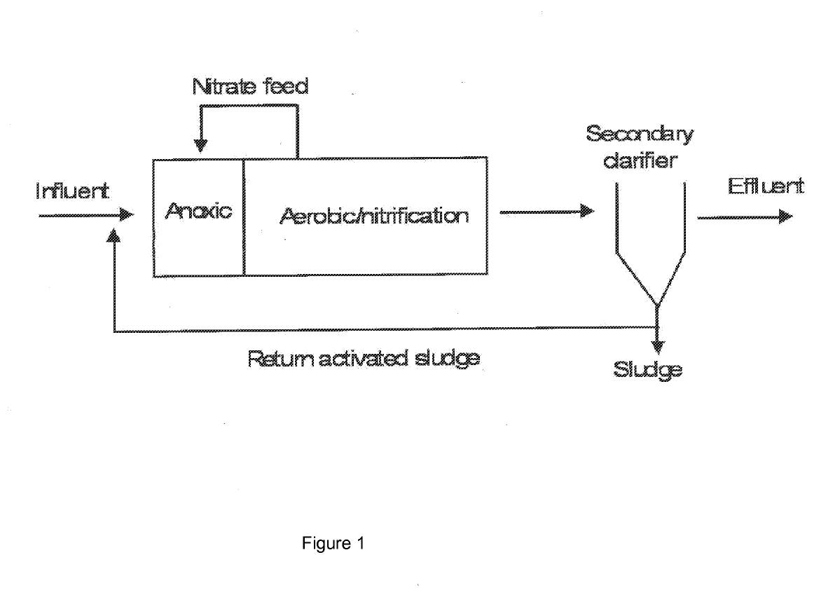

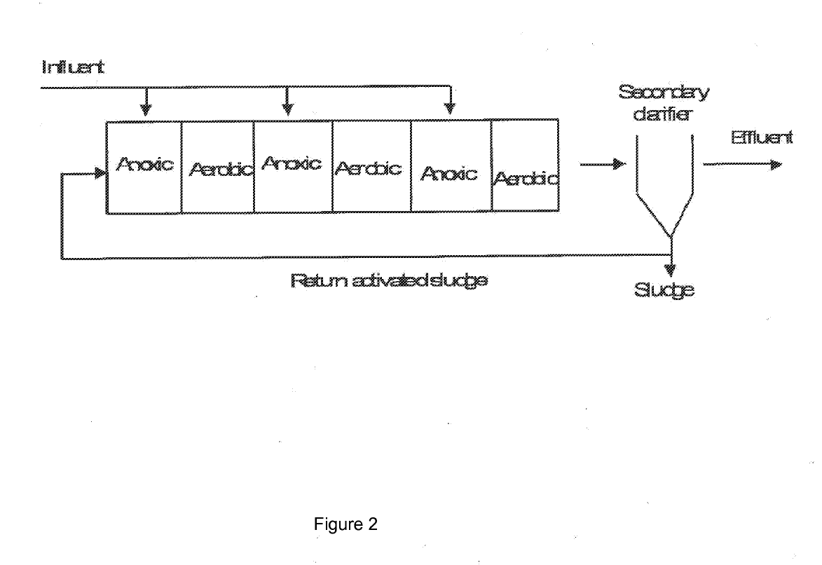

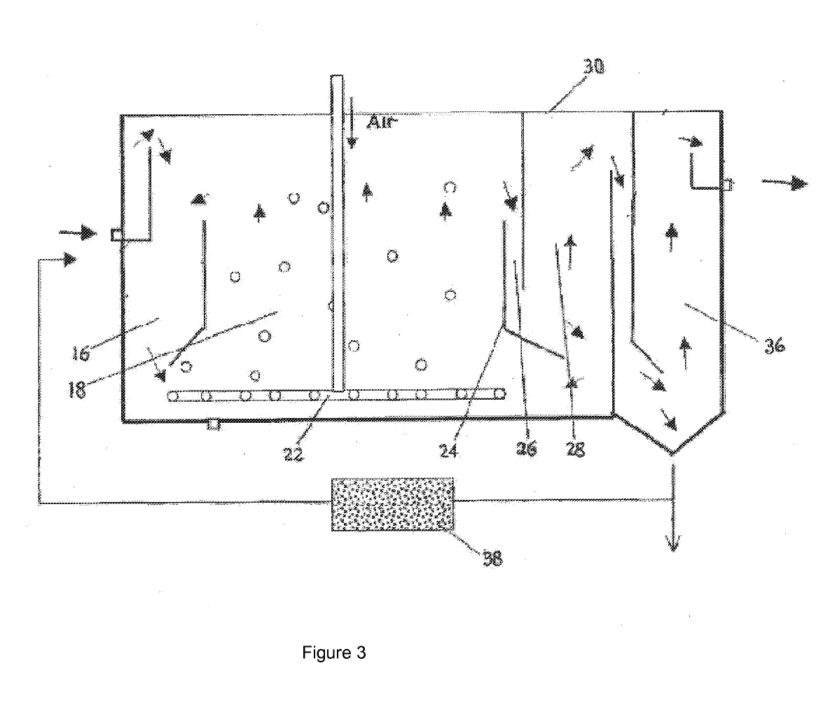

### DESCRIPTION

For the purposes of promoting an understanding of the principles of the claimed technology and presenting its currently understood best mode of operation, reference will now be made to the embodiments illustrated in the drawings and specific language will be used to describe the same.

It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

Appropriate mixing is extremely important for biological reactions. In aerobic reactors, the air supplied for oxygen demand is normally sufficient for mixing needs so additional mixing devices are typically not needed. However, mechanical mixing devices are commonly used in anoxic and anaerobic processes due to the negative effects of dissolved oxygen to these processes. Conventional mixing methods, including mechanical mixing devices or air mixing devices, are continuously operated. In order to completely mix the reactor, these types of mixers consume significant amount of energy or significantly increase the dissolved oxygen in the reactor. In addition, mechanical mixing devices need regular maintenance, and continuous-flow air mixing devices provide only mild local mixing.

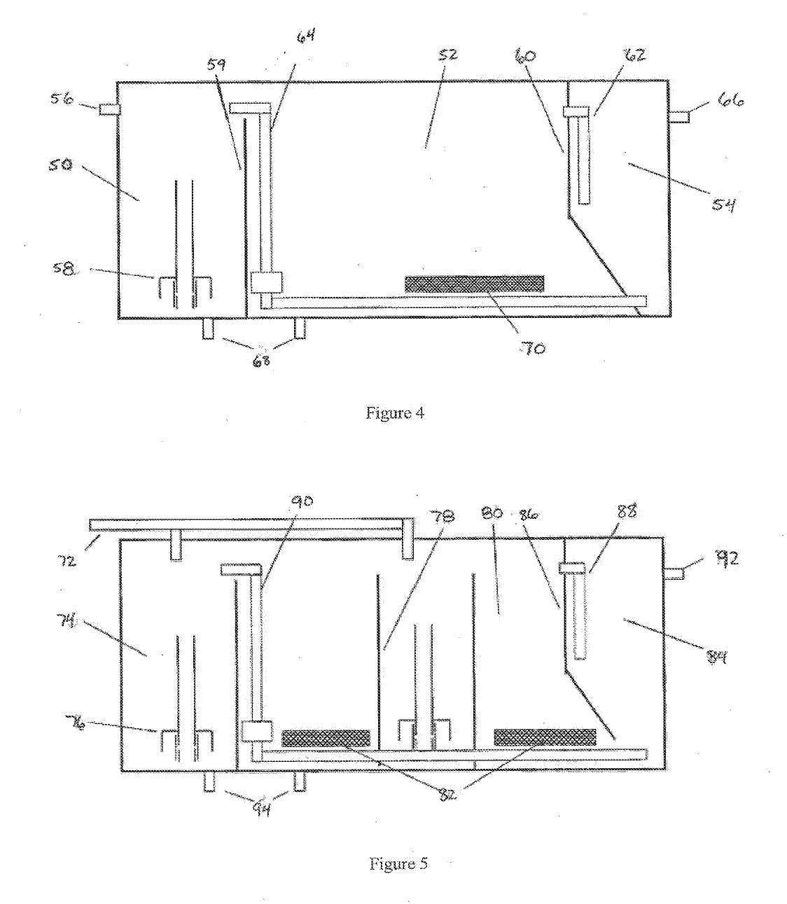

FIG. 4 illustrates a cross-sectional side view of a preferred embodiment of the first invention. The bioreactor of this invention is separated into a mixing zone that is under anoxic or anaerobic conditions (50), an aerobic zone (52), and a static zone (54). These zones may be separated by baffles (59, 60). Influent flows into the reactor through the inlet (56) and into the mixing zone (50) where it mixes with established biomass and where denitrification is performed if the mixing zone is under an anoxic condition. If the mixing zone (50) is under an anaerobic condition, phosphorus accumulating organisms (PAOs) can be cultured to remove phosphorus. A mixing device (58) driven by air that could provide surge lifting action is used to increase biological kinetics in the anaerobic zone. Although the drawing shows solids being returned form the static zone (54) to the mixing zone (50) it is understood that the same goal could be accomplished by returning solids from the static zone (54) to the aerobic zone (52) and from the aerobic zone (52) to the mixing zone (50).

The mixed liquor leaves the mixing zone (50) and enters the aerobic zone (52) where BOD is degraded and nitrification is performed if a long sludge age is maintained. The mixed liquor flows from the aerobic zone (52) into the static zone (54). The static zone (54) includes a settling baffle (60) that may or may not extend to the bottom of the reactor, as well as a conduit (62) that serves to redirect incoming flow towards the bottom of the static zone (54).

Solids settle in the static zone (54) before being pulled back into the aerobic zone via vacuum if the settling baffle (60) doesn't extend to the bottom of the reactor. Sludge solids are also returned to the mixing zone (50) via pumping device (64), which may be a conventional pump, a conventional air-lift type pump, or an air-lift pump such as those described later herein. Said pumping device (64) may return solids from either the aerobic zone (52) or the static zone (54). If the settling baffle (60) extends to the bottom of the reactor then solids must be returned from the static zone (54). Effluent exits the reactor through the outlet (66), and the reactor may be drained via one or more drain(s) (68) sited at a desirable location. Alternative embodiments may also include an aeration device (70) such as those known in the art.

An additional mixing zone can be placed ahead of the above mixing zone-aerobic zone design, and sludge from the static zone can be returned to either mixing zones. If it is returned to the second mixing zone, the mixed liquor in the second mixing zone may be returned to the first mixing zone. These arrangements allow the three reaction zones to be under anaerobic-anoxic-aerobic conditions in series, to achieve both nitrogen removal and phosphorus removal. All mixing and liquid transport devices may be air-driven and can perform surge lifting action.

Alternatively, some or all of the mixing and/or transport devices may be powered by electricity, hydraulics, or other suitable means.

FIG. 5 illustrates a cross-sectional side view of a another embodiment in accordance with the disclosed technology. Although two pairs of anoxic/aerobic cells are shown in this particular embodiment, more than two pairs are possible and should be considered intuitive to forms of this embodiment. Influent enters the reactor through an inlet (72) and enters at least one of the mixing zones (74) that are under anoxic condition. A mixing device (76) that is able to provide surge lifting action is used to increase biological kinetics in the mixing zone, and is shown in this particular example as an air-lift device as described later herein. In other embodiments, other types of mixing devices may also be used.

Influent and return sludge from the mixing zone (74) flows through separation walls (78) and proceeds into other zones, at least one of which will be an aerobic zone (80) where an aeration device (82) optionally may be located to mix the volume and provide oxygen for organic matter degradation and nitrification. Finally, it will reach a static zone (84) that is defined by a settling baffle (86) that may or may not extend to the bottom of the reactor, and a conduit (88) that redirects inflow toward the bottom of the static zone (84).

Sludge solids settle to the bottom of the static zone (84) where they may be automatically returned to the preceding aerobic zone (80) if the settling baffle (86) doesn't extend to the bottom of the reactor. Whether the settling baffle (86) does or does not extend to the bottom of the reactor, the solids at the bottom of the static zone (84) are conveyed at least to the first mixing zone (74) via a pumping device (90). Although not illustrated, additional means for the return of solids should be considered intuitive to the design of this embodiment. This embodiment is displayed with a settling baffle (86) that doesn't extend to the bottom of the reactor, but alternative embodiments may include a baffle that extends to the bottom of the reactor.

Supernatant in the static zone (80) leaves the reactor as effluent through an outlet (92). The reactor may be drained via one or more drain(s) (94).

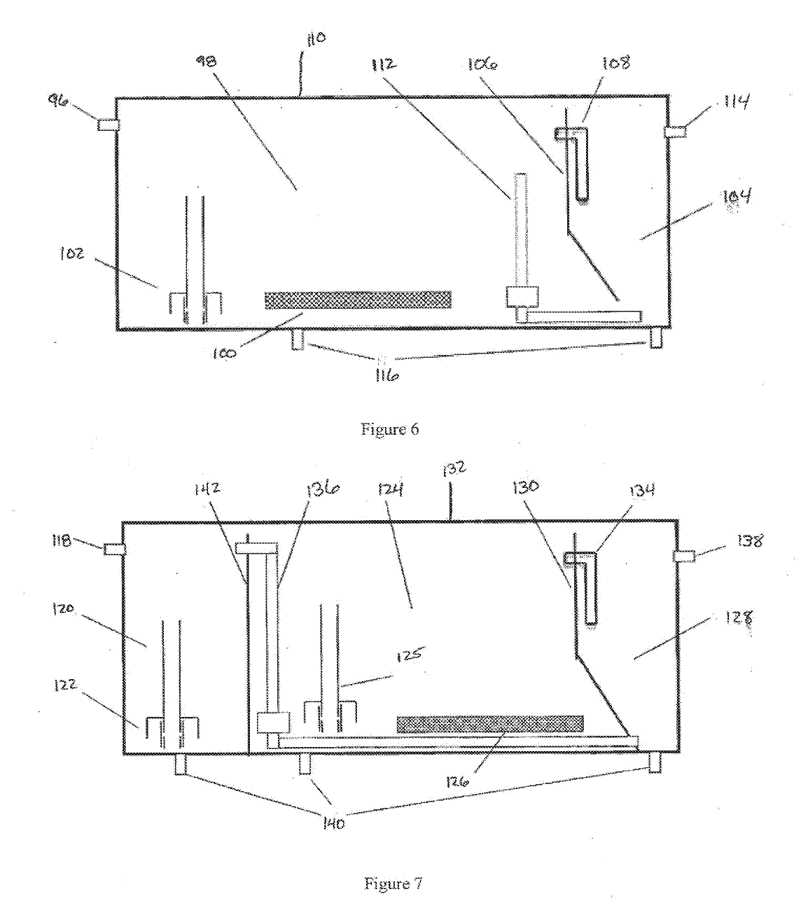

FIG. 6 illustrates a cross-sectional side view of another embodiment in accordance with the disclosed technology. Influent enters the reactor through an inlet (96) and enters the alternating reaction zone (98). The alternating reaction zone (98) is afforded aeration via an aeration device (100) and/or mixing via a mixing device (102), which is illustrated in FIG. 6 as an embodiment of the air-lift device described later herein. Alternative embodiments may omit the aeration device and/or the mixing device. Still other embodiments may include multiple aeration and/or mixing devices as desired. By alternating between aerobic and anaerobic conditions the reactor can accomplish nitrification and denitrification in the same vessel.

The mixed liquor leaves the alternating reaction zone (98) and enters the static zone (104), which is defined by a settling baffle (106) that may or may not extend to the bottom of the reactor, and a conduit (108) that redirects inflow toward the bottom of the static zone (104).

Sludge solids settle to the bottom of the static zone (104) where they may be automatically returned to the alternating zone (98) (if desired) if the settling baffle (106) doesn't extend to the bottom of the reactor (110). In this event forced sludge return may not be necessary. However, whether the settling baffle (106) does or does not extend to the bottom of the reactor, the solids at the bottom of the static zone (104) may be conveyed back to the alternating zone (98) via a pumping device (112). This embodiment is displayed with a settling baffle (106) that doesn't extend to the bottom of the reactor, but other embodiments may include a baffle which extends to the bottom of the reactor (110). Supernatant in the static zone (104) leaves the reactor as effluent through an outlet (114). The reactor may be drained via one or more drain(s) (116).

FIG. 7 illustrates a cross-sectional side view of an alternative embodiment of the disclosed technology. Influent enters the reactor via inlet (118) and flows into a mixing zone (120) that is mixed by a mixing device (122). The purpose of this front mixing zone is to enhance biological phosphorous removal and nitrogen removal, and is operated under anaerobic and anoxic conditions, depending on the operation cycle of the treatment process. The liquor leaves the mixing zone (120) and enters the alternating zone (124), which is separated by a baffle (142).

The alternating zone (124) may be afforded aeration via an aeration device (126) and/or mixing via a mixing device (125), if desired. The mixed liquor leaves the alternating zone (124) and enters the static zone (128), which is defined by a settling baffle (130) that may or may not extend to the bottom of the reactor (132), and a conduit (134) that redirects inflow toward the bottom of the static zone (128).

Sludge solids settle to the bottom of the static zone (128) where they may be automatically returned to the alternating zone (124) if the settling baffle (130) doesn't extend to the bottom of the reactor. Whether the settling baffle (130) does or does not extend to the bottom of the reactor, the solids at the bottom of the static zone (128) may be conveyed back at least to the mixing zone (120) via one or more pumping devices (136), but may also be returned to the alternating reaction zone (124), as desired. In addition, solids could also be returned from the alternating reaction zone (124) back to the mixing zone (120). Supernatant in the static zone (128) leaves the reactor as effluent through the outlet (138). The reactor may be drained via one or more drains (140).

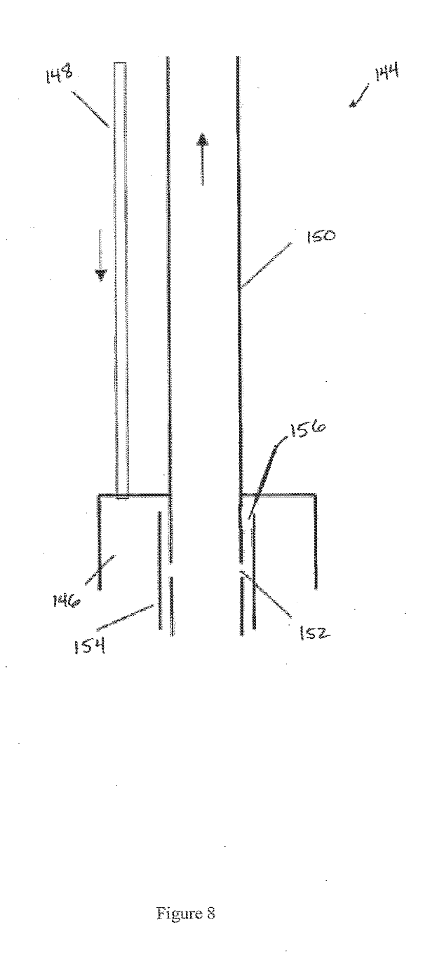

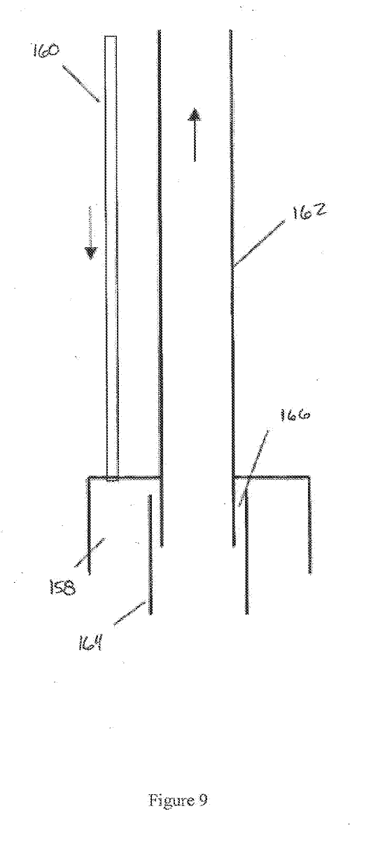

FIG. 8 illustrates a cross-sectional side view of one embodiment of an air-lift type device. This embodiment features a liquid lifting device (144) (i.e., surge lifting device) that coalesces and releases gas periodically in large diameter bubbles to improve upon the conventional airlift pump design. Gas enters the gas collection chamber (146) through either a gas supply line (148) as shown or by rising from a source below the device (not shown). In some applications the housing of the gas collection chamber (146) can be further extended to below the bottom of the riser (150).

Once the small bubbles enter the gas collection chamber (146) they coalesce and form a large bubble. The volume of this bubble expands downward until it reaches the orifice (152) that is protected by the orifice baffle (154) that is open on the top and bottom to prevent clogging. Once the gas volume reaches the orifice (152) the entire gas volume flows through the gas conduit (156) from the top of the baffle (154), through the orifice (152), and into the upper riser (150).

The gas bubble fills the upper riser (150) and pushes and pulls tank content from the bottom of the device to the top of the device where it is released. In this embodiment the orifice (152) is cut into the upper riser (150) which then extends down to form the base of the device. The type of tank, vessel, or container wherein such a lifting device (144) may be used can vary according to application. Additionally, the disclosed pump may be used to move a variety of different liquids and/or solids. In other embodiments, a gas or gasses other than air may be used to drive the pumping action.

FIG. 9 illustrates a cross-sectional side view of a secondary embodiment in accordance with the third invention. Gas enters the gas collection chamber (158) through either a gas supply line (160) as shown or by rising from a source below the device. Once the small bubbles enter the gas collection chamber (158) they coalesce and form a large bubble. The volume of this bubble expands downward until it reaches the bottom of the upper riser (162). Once the bubble breaches the bottom of the upper riser (162) the entire gas volume flows over the top of the lower riser (164), through the gas conduit (166), and into the upper riser (162) where it proceeds to lift the fluid. In this embodiment the lower riser (164) extends down to form the base of the device. In some applications the housing of the gas collection chamber (158) can be further extended to below the bottom of the lower riser (164).

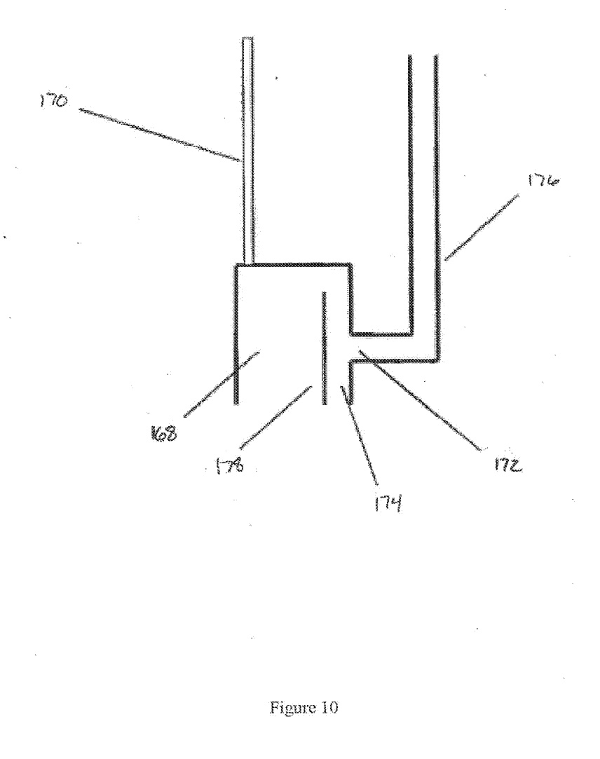

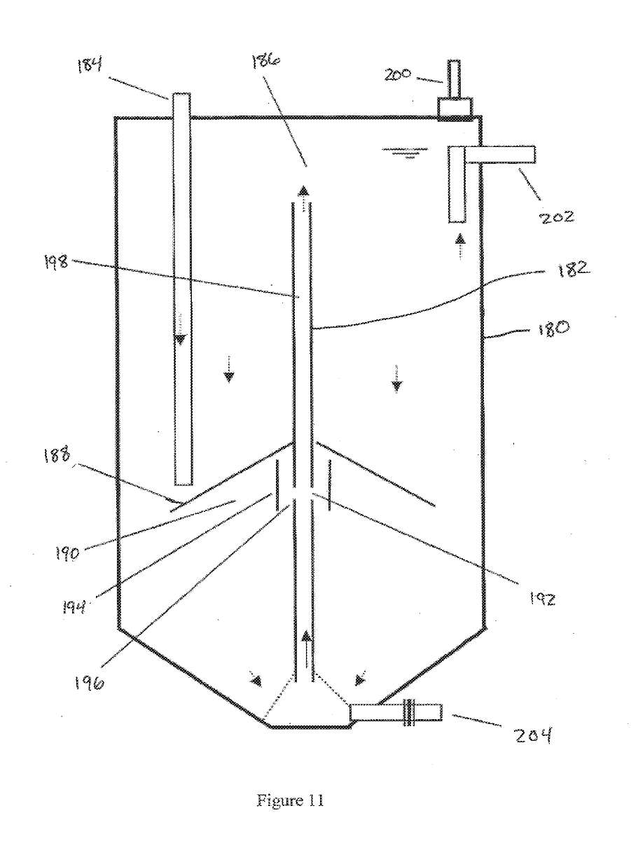

FIG. 10 illustrates a cross-sectional side view of a tertiary embodiment in accordance with the third invention. Gas enters the gas collection chamber (168) through either a gas supply line (170) or by rising from a source below the device. Once the small bubbles enter the gas collection chamber (168) they coalesce and form a large bubble. The volume of this bubble expands downward until it reaches the portion of the orifice (172) which is separated from the collection chamber (168) by a baffle (178). Once the bubble breaches the orifice (172) the entire gas volume flows through the top of the gas conduit (174) and enters the upper riser (176). The key difference between this embodiment and the other two embodiments is that once the gas enters the upper riser (176) it will pull liquid and solids through the gas conduit (174) and orifice (172) and into the upper riser.

FIG. 11 illustrates a cross-sectional side view of one embodiment of the disclosed technology wherein a reaction vessel (180) includes a lift pump (182) similar to those described with respect to FIGS. 8-10. Feed is introduced into the reactor via inlet (184) and flows into the mixing zone (186) that is under anaerobic condition. There it mixes with, and is consumed by, anaerobic bacteria which produce useful gas, such as methane, as a metabolic byproduct. As gas bubble nucleate in the reactor and float upward through the anaerobic zone (186) they are captured by the gas collection collar (188) and begin to coalesce in the gas collection chamber (190). The gas expands in volume until it reaches the top of the orifice (192) that is protected by the orifice baffle (194). At this point the gas flows through the gas conduit (196) and the orifice (194) before entering the upper riser (198). As the gas travels through the upper riser (198) it pulls solids (if any) from the bottom of the reactor and deposits them at the top; effectively mixing the reactor. Accumulated gas leaves the reactor via gas outlet (200). Effluent from the reactor leaves through an liquid outlet (202), and the reactor can be drained through the drain (204). Alternative embodiments may include more or fewer inlets, gas outlets, liquid outlets, and/or drains as desired.

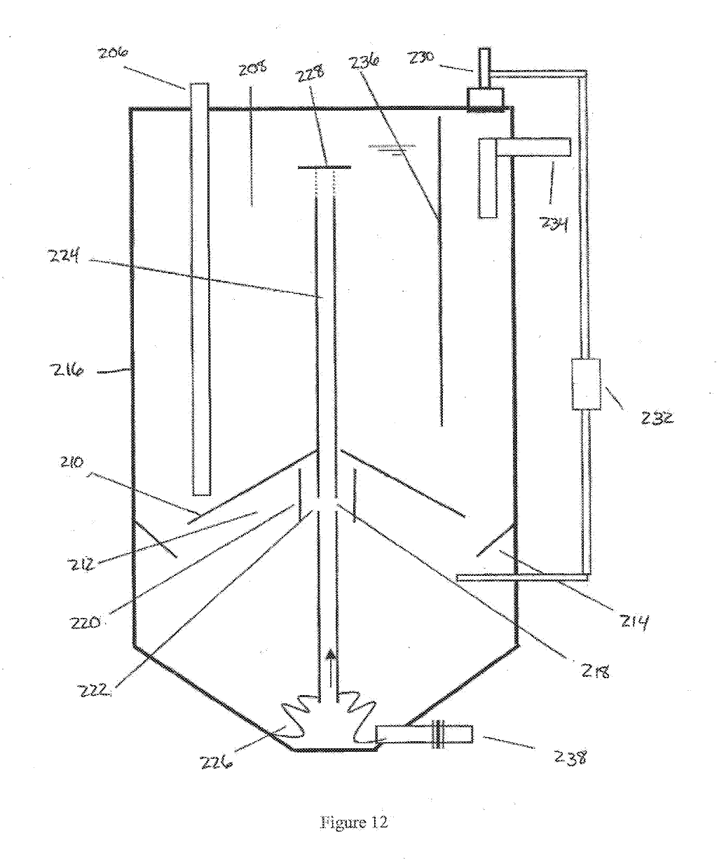

FIG. 12 illustrates a cross-sectional side view of another embodiment in accordance with the disclosed technology. This particular embodiment shows optional performance-improving components that may be added individually or collectively to the embodiment seen in FIG. 11. Feed is introduced into the reactor via inlet (206) and flows into the mixing zone (208). There it mixes with, and is consumed by, anaerobic bacteria which produce useful gas, such as methane, as a metabolic byproduct. As gas bubble nucleate in the reactor and float upward through the mixing zone (208) they are captured by the gas collection collar (210) and begin to coalesce in the gas collection chamber (212). Gas that would otherwise bypass the gas collection collar (210) is redirected into the gas collection volume (212) by the gas collection baffle (214) that typically extends inward around the periphery of the reactor (216).

The gas expands in volume until it reaches the top of the orifice (218) that is protected by the orifice baffle (220). At this point the gas flows through the gas conduit (222) and the orifice (218) before entering the upper riser (224). As the gas travels through the upper riser it pulls solids from the bottom of the reactor and deposits them at the top; effectively mixing the reactor. As the mixing device fills with and releases gas there is significant buoyant force occurring inside the device. Therefore, a means of elastic connection (226) may be incorporated with or without a force mitigation plate (228) so that the device will oscillate once the gas is released through the upper riser (224). Oscillation of the entire device will more thoroughly mix the reactor.

While accumulated gas leaves the reactor via gas outlet (230), it can also be recycled below the gas collection collar (210) via recycle pump (232). This optional component can allow the operator to force-mix the device at any time. Effluent from the reactor leaves through the outlet (234), but performance may be increased by adding an optional outlet baffle (236). The purpose of the outlet baffle (236) is to decrease the amount of active sludge that leaves the reactor in the effluent. The reactor can be drained through the drain (238).

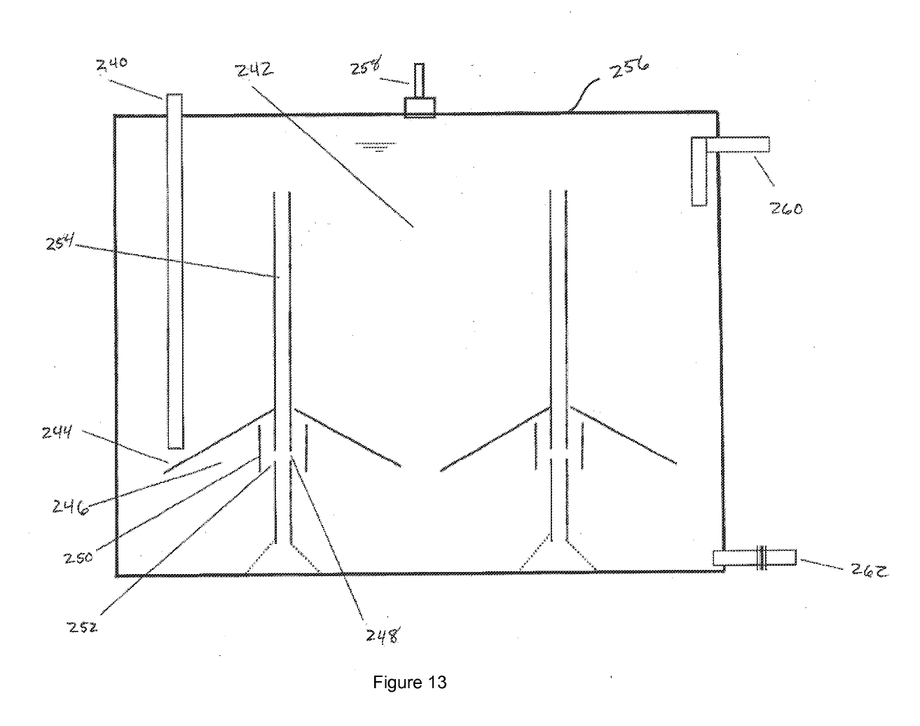

FIG. 13 illustrates a cross-sectional side view of still another embodiment in accordance with the disclosed technology. This embodiment shows how multiple mixing devices can be situated next to each other in the same volume to improve performance or when fabricating larger reactors. Feed is introduced into the reactor via inlet (240) and flows into the anaerobic zone (242). There it mixes with, and is consumed by, anaerobic bacteria which produce useful gas, such as methane, as a metabolic byproduct. As gas bubble nucleate in the reactor and float upward through the anaerobic zone (242) they are captured by the gas collection collar (244) and begin to coalesce in the gas collection chamber (246). The gas expands in volume until it reaches the top of the orifice (248) that is protected by the orifice baffle (250). At this point the gas flows through the gas conduit (252) and the orifice (248) before entering the upper riser (254). As the gas travels through the upper riser (254) it pulls solids from the bottom of the reactor and deposits them at the top; effectively mixing the reactor (256).

Accumulated gas leaves the reactor via gas outlet (258). Effluent from the reactor leaves through the outlet (260), and the reactor can be drained through the drain (262). All of the optional components of note in FIG. 12 may be included in this embodiment or similar embodiments as desired.

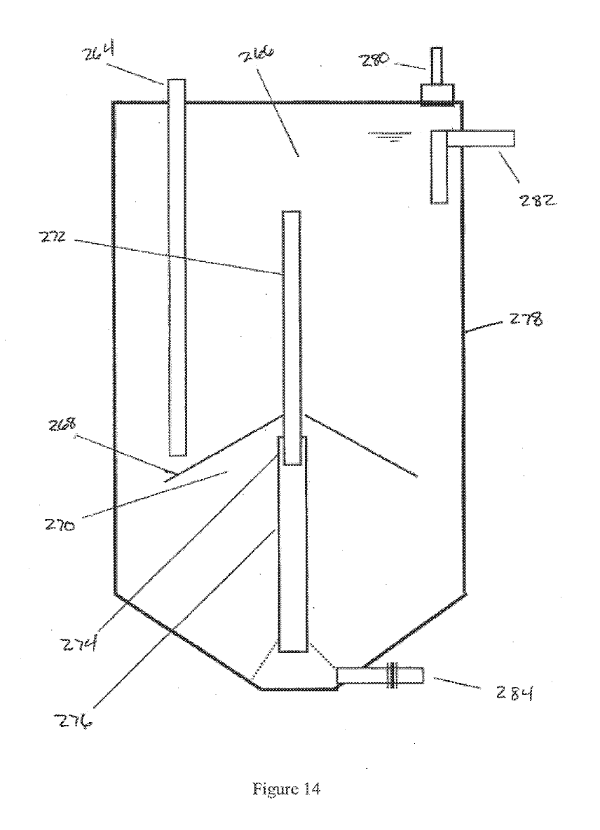

FIG. 14 illustrates a cross-sectional side view of another embodiment in accordance with the disclosed technology. This particular embodiment shows an automatic mixing device such as that disclosed in FIG. 8 replaced with the automatic mixing device such as that disclosed in FIG. 9. Feed is introduced into the reactor via inlet (264) and flows into the anaerobic zone (266). There it mixes with, and is consumed by, anaerobic bacteria which produce useful gas, such as methane, as a metabolic byproduct. As gas bubble nucleate in the reactor and float upward through the anaerobic zone (266) they are captured by the gas collection collar (268) and begin to coalesce in the gas collection chamber (270). The gas expands in volume until it reaches the bottom of the upper riser (272). At this point the gas flows through the gas conduit (274) created by the lower riser (276) extending over the upper riser (272), and into the upper riser (272). As the gas travels through the upper riser (272) it pulls solids from the bottom of the reactor and deposits them at the top; effectively mixing the reactor. Accumulated gas leaves the reactor (278) via gas outlet (280). Effluent from the reactor leaves through the outlet (282), and the reactor can be drained through the drain (284). All of the optional components described in the discussion of FIG. 12 may optionally be included in this embodiment as well.

Operation

Embodiments in FIGS. 4 and 5 are operated in such a way so that wastewater first enters the bioreactor through the inlet and enters one or more mixing zones. Organic carbon in the influent is used as the electron donor during the denitrification process and nitrate or nitrite is converted into nitrogen gas. If no nitrate or nitrite is present then the influent carbon is utilized to prime phosphorous accumulating organisms by encouraging them to release more phosphorous in preparation to uptake a net increase in phosphorous once they are exposed to aerobic conditions. Under aerobic conditions BOD degradation is achieved and ammonia is converted to nitrate and/or nitrite. Settled sludge containing nitrate and/or nitrite must be returned from the static zone to a mixing zone for denitrification, thereby removing nitrogen from the system.

The vast majority of solids are retained within the reactor via static zone and automatic or forced solids return. Solids concentration in the reactor is controlled by wasting sludge directly from the reactor. Additional clarification or filtration may be performed downstream of the reactor for final polishing (if desired), but it is typically unnecessary to return sludge from the polishing unit to the reactor.

Embodiments in FIGS. 6 and 7 have, at their core, an alternating reactor. These embodiments are typically operated in batch fashion with flow being applied only when the alternating zone is under anaerobic/anoxic conditions. Doing so provides a carbon source to drive denitrification. Were the reactor to be operated under continuous flow conditions it is likely that the concentration of nitrogen species (e.g., nitrate, ammonia, etc.) would increase to undesirable levels, but this is dependant on the installation and discharge requirements. As with embodiments in FIGS. 4 and 5, the majority of solids are retained within the reactor with solids concentration being controlled by direct wasting from the reactor. A clarifier or other polishing method may be used downstream from this reactor, but solids return from the polishing device is typically not necessary.

The embodiment in FIG. 7 has a continuous mixing zone that may be under anaerobic or anoxic conditions before the alternating zone. In this embodiment flow is applied directly to the mixing zone from the inlet. Sludge is recycled to the mixing zone from the static zone. Sludge would be wasted from the alternating zone at the end of the aerobic period to maximize biological phosphorous removal.

Embodiments in FIGS. 8, 9, and 10 operate through the collection and coalescing of small gas in a chamber until a critical volume is reached. The gas then evacuates the chamber and enters a riser which pushes and pulls liquid and solids within or under the riser. The gas provided to the device can be derived either directly from an air line or indirectly by collecting bubbles as they rise to the surface. If the latter method is employed the bubbles can come from a diffuser, an open air line, or can nucleate from the liquid.

Embodiments in FIGS. 11 through 14 operate under anaerobic conditions. Feed comprising waste sludge from wastewater treatment plants, raw human waste, raw animal waste, or any highly active organic slurry can be used to drive the reactor. The efficiency of the mixing device is dependant on the activeness of the feed and the temperature of the reactor. When the reactor is fed through the inlet an equal volume of effluent can be expected from the outlet. Gas is collected once it leaves the gas outlet and can be stored, burned, or processed for use in machines such as internal combustion engines.

Reaction vessels, biological reactors, and the like which incorporate one or more of the technologies disclosed herein may exhibit some or all of the following advantages over existing reaction devices:

(a) In the bioreactor of this invention, more sludge can be returned back to the mixing zone, thus the microorganism concentration in the bioreactor can be increased relative to conventional suspended-growth bioreactors. As a result, the performance and effluent quality of the bioreactor can be improved.

(b) Because of the increase of the microorganism concentration, the bioreactor of this invention can be operated in a higher volumetric loading, resulting in the reduced bioreactor size and reduced construction cost.

(c) In the bioreactor of this invention, the internal sludge return function replaces the sludge returned from the secondary clarifier, thus the external sludge return from the clarifier can be eliminated, resulting in simplified operation and reduced energy consumption for sludge return.

(d) The elimination of sludge return rate from the secondary clarifier allows only the excess sludge to be carried to the secondary clarifier, thereby reduces the clarifier solids loading and improves the clarifier effluent quality.

(e) Since the invention can be easily implemented, existing suspended-growth bioreactors such as aeration tanks can be easily modified to the bioreactor of this invention by adding baffles to create an internal sludge return and pre-anoxic zone(s). Thus, the capacity of the existing wastewater treatment plants that employ suspended-growth bioreactors such as activated sludge wastewater treatment plants can be increased for very low cost modification. This avoids very costly major expansions of the existing plants and the construction of new plants once the design capacity of the existing plants is reached.

(f) Adding multiple anoxic/aerobic zone combinations and dosing each anoxic zone with a portion of the influent will allow the reactor to provide comprehensive total nitrogen removal through nitrification/denitrification. Because of denitrification, the process recycles the oxygen in the nitrate and nitrite form for organic pollutant removal, which further reduces the oxygen demand. Therefore, energy cost for aeration can be reduced. Moreover, the denitrification reduces the nitrate and nitrite concentrations in the effluent, resulting in the improved effluent quality.

(g) By implementing an alternating aerobic-anoxic function, the influent organic matter can be utilized to perform denitrification. Therefore, no external carbon addition is needed to achieve comprehensive nitrogen removal through the aerobic-anoxic cycling process, resulting in significant savings in construction and operation costs.

(h) Using a single volume to apply both aerobic and anoxic treatment simplifies the construction and operation, leading to significant cost savings from construction, operation, and maintenance.

(i) When the non-aeration period is extended to form anaerobic conditions, biological phosphorus removal can also be achieved, resulting in comprehensive wastewater treatment using the same volume, with minimum construction, operation, and maintenance costs.

(j) As a result of more intensive mixing than a conventional biogas generators, the present invention can achieve a higher rate, and makes it possible to use a smaller reactor to treat the equivalent amount of organic waste or realize a greater gas production and more complete digestion than if the same sized conventional digester is used.

(k) Due to the self-actuating mixing function, the present invention eliminates energy inputs needed to mix reactor. Therefore, net energy output is higher when compared to other biogas generators. It also allows reactor to be operated off-grid in rural or undeveloped regions.

(l) Lack of mechanical mixing devices reduces operational and maintenance inputs to the reactor. This, combined with the smaller size requirement, reduces capital and operational costs of other reactors. It extends the viable market of the reactor to undeveloped countries.

(m) The surge lifting device, in this case the pump riser and gas collection collar, not only results in more comprehensive mixing of the entire reactor, but also prevents sludge build up at the digester bottom, and also helps to break up the floating sludge within the digester, thereby improving the digester performance while reducing the need to clean the digester regularly.

(n) The three-way channel design of the surge lifting device eliminates the potential for clogging of the large bubble creator in certain applications;

(o) Large bubbles created by the surge lifting device reduce oxygen transfer from the bubbles to the surrounding liquid so that specific environmental conditions can be maintained within the liquid.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. A biological reactor for treating water and wastewater comprising:
(a) a tank having an inlet and an outlet;
(b) a means separating said tank into a mixing zone, an aerobic zone, and a static zone;
(c) said mixing zone connected to the inlet of the tank comprising a means for mixing;
(d) said aerobic zone comprising means to impart oxygen to, and mix, the zone;
(e) said static zone connected to the outlet of the tank;
(f) said means of mixing driven by air and able to creating periodic surge lifting motion of the liquid;
(g) a means to return sludge from said static zone to said mixing zone.

2. The apparatus of claim 1 wherein a means of utilizing multiple mixing zones is employed with influent being applied to the first mixing zone and sludge being returned from said static zone to said mixing zones.

3. The apparatus of claim 1 wherein a means of utilizing multiple mixing zone and aerobic zone combinations is employed with influent being applied to all mixing zones and sludge being returned from said static zone to the mixing zone farthest upstream.

4. A biological reactor for treating water and wastewater comprising:
(a) a tank having one inlet and one outlet;
(b) a means separating said tank into two zones; one alternating reaction zone and one static zone;
(c) a means of mixing and a means of aeration within said alternating reaction zone;
(d) said static zone connected to the outlet of the tank;
(e) a means to return sludge from said static zone to said alternating reaction zone;
(f) said means of aeration operated on a cycling on and off pattern;
(g) said means of mixing operated at least when said means of aeration is not on;
(h) a means of pumping influent to said alternating reaction zone at least part time when said means of aeration is not on.

5. The apparatus of claim 4, wherein an aerobic polishing zone is placed between said alternating reaction zone and said static zone.

6. The apparatus of claim 5, wherein a mixing zone comprising a means of mixing is placed before said alternating reaction zone, with a means to return sludge from said static zone to said mixing zone.

7. The apparatus of claim 4, wherein a mixing zone comprising a means of mixing is placed before said alternating reaction zone, with a means to return sludge from said static zone to said mixing zone.

8. A biological method for treating water and wastewater comprising:
(a) a tank having an inlet and an outlet;
(b) a means separating said tank into a mixing zone, an aerobic zone, and a static zone;
(c) said mixing zone connected to the inlet of the tank comprising a means for mixing;
(d) said aerobic zone comprising means to impart oxygen to, and mix, the zone;
(e) said static zone connected to the outlet of the tank;
(f) said means of mixing driven by air and able to creating periodic surge lifting motion of the liquid;
(g) a means to return sludge from said static zone to said mixing zone.

9. The method of claim 8 wherein a means of utilizing multiple mixing zones is employed with influent being applied to the first mixing zone and sludge being returned from said static zone to said mixing zones.

10. The method of claim 8 wherein a means of utilizing multiple mixing zone and aerobic zone combinations is employed with influent being applied to all mixing zones and sludge being returned from said static zone to the mixing zone farthest upstream.

11. A method of claim 8, wherein controlling the means for aeration is based on at least the effluent ammonia concentration from the aerobic zone.

12. The method of claim 11 further comprising a means to control sludge wasting based on the dissolved oxygen concentration within the aerobic zone.

13. A biological method for treating water and wastewater comprising:
(a) a tank having one inlet and one outlet;
(b) a means separating said tank into two zones; one alternating reaction zone and one static zone;
(c) a means of mixing and a means of aeration within said alternating reaction zone;
(d) said static zone connected to the outlet of the tank;
(e) a means to return sludge from said static zone to said alternating reaction zone;
(f) said means of aeration operated on a cycling on and off pattern;
(g) said means of mixing operated at least when said means of aeration is not on;
(h) a means of pumping influent to said alternating reaction zone at least part time when said means of aeration is not on.

14. The method of claim 13, wherein an aerobic polishing zone is placed between said alternating reaction zone and said static zone.

15. The method of claim 13, wherein a mixing zone comprising a means of mixing is placed before said alternating reaction zone, with a means to return sludge from said static zone to said mixing zone.

16. The method of claim 13, wherein a mixing zone comprising a means of mixing is placed before said alternating reaction zone, with a means to return sludge from said static zone to said mixing zone.

17. A method of claim 13, wherein controlling the means for aeration is based on at least the effluent ammonia concentration from the aerobic zone.

18. The method of claim 17 further comprising a means to control sludge wasting based on the dissolved oxygen concentration within the aerobic zone.

19. An apparatus for treating organic waste or wastewater comprising:
(a) a tank having an inlet, an outlet, a gas outlet, and a means of mixing;
(b) said means of mixing driven by gas and able to creating periodic surge lifting motion of the tank content.

20. The apparatus of claim 19, further comprising a means to direct all gas to said means of mixing, and/or means to return biogas back to said means of mixing, means to reduce the amount of solids in the effluent by retaining them in the tank, means to allow said means of mixing to oscillate.

21. The apparatus of claim 19, further comprising multiple means of mixing within a single tank.

22. A method for treating organic waste or wastewater comprising:
(a) a tank having an inlet, an outlet, a gas outlet, and a means of mixing;
(b) said means of mixing driven by gas and able to creating periodic surge lifting motion of the tank content.

23. The method of claim 22, further comprising a means to direct all gas to said means of mixing, and/or means to return biogas back to said means of mixing, means to reduce the amount of solids in the effluent by retaining them in the tank, means to allow said means of mixing to oscillate.

24. The method of claim 22, further comprising multiple means of mixing within a single tank.

25. An apparatus for lifting liquid and/or solids in liquid comprising:
(a) a riser tube to direct liquid and/or solids in liquid;
(b) a volume in which gas may collect and coalesce;
(c) a three-way conduit between said riser and said gas volume that allows gas to flow from said gas volume into said riser at once;
(d) a gas source.

26. An apparatus for lifting liquid and/or solids in liquid comprising:
(a) a riser tube to direct liquid and/or solids in liquid;
(b) a volume encompassing at least a portion of said riser tube in which gas may collect and coalesce;
(c) a lower riser tube that encompasses the upper riser tube with an opening between the inner wall of the lower riser and the outer wall of the upper riser.
(d) a gas source

27. A method for lifting liquid and/or solids in liquid comprising:
(a) a riser tube to direct liquid and/or solids in liquid;
(b) a volume in which gas may collect and coalesce;
(c) a three-way conduit between said riser and said gas volume that allows gas to flow from said gas volume into said riser at once;
(d) a gas source.

28. An method for lifting liquid and/or solids in liquid comprising:
(a) a riser tube to direct liquid and/or solids in liquid;
(b) a volume encompassing at least a portion of said riser tube in which gas may collect and coalesce;
(c) a lower riser tube that encompasses the upper riser tube with an opening between the inner wall of the lower riser and the outer wall of the upper riser;
(d) a gas source.
